(19) United States
(12) Patent Application Publication
(10) Pub. No.: US 2026/0235146 A1
(43) Pub. Date: Aug. 13, 2026

(54) DOUBLE-SUPPORT FASTENING DEVICE FOR A SHUTTERED STRUCTURE

(71) Applicant: A. RAYMOND ET CIE, GRENOBLE (FR)

(72) Inventors: Olivier Bizzini, GRENOBLE (FR); Stéphane Gélibert, GRENOBLE (FR); Nicolas Petitfils, GRENOBLE (FR); Marc De Bortoli, GRENOBLE (FR); Jean-Paul Yonnet, GRENOBLE (FR); Philippe Tenaud, GRENOBLE (FR)

(21) Appl. No.: 19/153,423

(22) PCT Filed: Feb. 8, 2024
(86) PCT No.: PCT/FR2024/050176

§ 371 Date: Aug. 4, 2025

(30) Foreign Application Priority Data
Feb. 9, 2023 (FR) 23/01233

(51) Int. Cl. F16B 1/00

(52) U.S. Cl. CPC F16B 1/00

(57) ABSTRACT

An attachment device for attaching an external functional element to a formed structure, the structure includes a first formwork element and a second formwork element. The attachment device includes an inner part intended to be embedded in the formed structure and which includes a first portion internally defining a receiving region that opens to the outside via a first peripheral edge; a holding element; a second portion which has a second peripheral edge configured to be in contact with a second internal wall of the second formwork element; an attachment portion defining a first securing element, the attachment device including an external part which has a second attachment element configured to be rigidly attached to the attachment portion of the internal part.

### CROSS-REFERENCE TO RELATED APPLICATIONS

This application is a 35 U.S.C. § 371 National Stage patent application of PCT/FR2024/050176, filed on 8 Feb. 2024, which claims the benefit of French patent application 23/01233, filed on 9 Feb. 2023, the disclosures of which are incorporated herein by reference in their entirety.

### TECHNICAL FIELD

The present disclosure relates to the field of construction and more particularly to a fastening device intended to ensure the fastening of an external functional element on a shuttered structure, such as a shuttered wall or a shuttered slab for example, the shuttered structure extending substantially parallel to an orientation axis and being obtained by pouring and hardening of a pouring fluid inside a formwork including at least one formwork element, such as a shuttering panel.

### STATE OF THE ART

It is known from the prior art to clad the outer face of constructions made with concrete walls with a cladding or a facing in order to obtain the desired level of finish or also in order to add a thermal and/or acoustic insulation for example. The installation of the cladding/facing is generally carried out by drilling and then inserting a plurality of retaining mechanisms on the outer face of the concrete walls. Although simple in design, this technical solution has the disadvantages of requiring time-consuming and tedious steps on a construction site.

### SUMMARY

The technical problem underlying the disclosure consists in particular in providing a fastening device making it possible to fasten an external functional element to a structure obtained by pouring in a shuttering panel, while being ergonomic, simple to use and economical.

To this end, the present disclosure relates to a fastening device intended to ensure the fastening of an external functional element on a shuttered structure, such as a shuttered wall or a shuttered slab for example, the shuttered structure extending substantially parallel to an orientation axis and being obtained by pouring and hardening of a pouring fluid inside a formwork including at least one first formwork element and one second formwork element, such as a shuttering panel, the fastening device including:
an internal part intended to be at least partially embedded in the shuttered structure, and which comprises:
   a) a first portion internally defining a receiving area emerging outwards at a first peripheral edge,
   b) a holding element, configured to be in contact with a first internal side of the first formwork element at the time of said pouring, the holding element being capable of occupying an insertion position in which all or part of the holding element is inserted inside a portion of the receiving area, the holding element being configured to be able to be removed from the receiving area,
   c) a second portion including a second peripheral edge configured to be in contact with a second internal side of the second formwork element,
   d) a fastening portion configured to be accessible from outside the shuttered structure after hardening of the pouring fluid and removal of the formwork, the fastening portion defining at least one first securing element,
the fastening device further including an external part which comprises a second securing element configured to be secured to the fastening portion of the internal part, the external part being intended to hold the external functional element in position relative to the internal part.

Thus, the fastening device allows the installation and the holding in position of an external functional element on a shuttered structure without having to resort to drilling or installing a fastening or bonding element after the hardening of the pouring fluid inside the formwork.

Also, the internal part is integrated into the shuttered structure before carrying out the pouring of the pouring fluid inside the formwork, which makes it possible to obtain an optimal pull-out resistance of the internal part inside the shuttered structure once the construction material has fully solidified.

The fastening device may further have one or several of the following characteristics, taken alone or in combination.

According to one embodiment of the disclosure, the external functional element may be a facing element, a plasterboard, an acoustic and/or thermal insulation panel, a scaffolding element, a rod, a casing, a beam, a rail or a slab for example.

According to one embodiment of the disclosure, the second securing element is configured to be secured by shape complementarity with the first securing element.

According to one embodiment of the disclosure, the first peripheral edge is configured to provide a seal for said pouring fluid vis-à-vis the receiving area, the first peripheral edge being substantially contained in a contact plane intended to be parallel to the orientation axis and to come against the first internal side of the first formwork element.

According to one embodiment of the disclosure, the holding element is flush with the first peripheral edge along the contact plane when the holding element occupies the insertion position.

According to one embodiment of the disclosure, the holding element protrudes relative to the first peripheral edge when the holding element occupies the insertion position, such that the holding element is in contact against the first formwork element without the peripheral edge being in contact against the first formwork element.

According to one embodiment of the disclosure, the first peripheral edge protrudes relative to the holding element when the holding element occupies the insertion position, so that the first peripheral edge is in contact against the first formwork element.

According to one embodiment of the disclosure, the holding element is configured to provide a seal for the pouring fluid vis-à-vis the receiving area when the holding element occupies the insertion position.

According to one embodiment of the disclosure, the holding element is configured to at least partially shut off the communication between the receiving area and the outside of the first portion when the holding element occupies the insertion position.

According to one embodiment of the disclosure, the holding element is configured to be completely detachable from the rest of the internal part. Advantageously, the holding element is removed in order to be reused during a subsequent implementation of the disclosure.

According to one embodiment of the disclosure, the second peripheral edge is configured to provide a seal for said pouring fluid vis-à-vis the fastening portion, the second peripheral edge being substantially contained in a plane intended to be parallel to the orientation axis and to come against the second internal side of the second formwork element at the time of pouring.

According to one embodiment of the disclosure, the first securing element is a fastening orifice, and the second securing element is a male element capable of being inserted inside said at least one fastening orifice following a movement oriented transversely to the orientation axis to occupy a locking position, the fastening orifice and the male element respectively defining a first retaining element and a second retaining element of the same retaining mechanism, said first retaining element and said second retaining element being complementary and capable of cooperating with each other so that the retaining mechanism ensures locking of the male element in its locking position inside the at least one fastening orifice.

According to one embodiment of the disclosure, the second securing element is a fastening orifice, and the first securing element is a male element capable of being inserted inside said at least one fastening orifice following a movement oriented transversely to the orientation axis to occupy a locking position, the fastening orifice and the male element respectively defining a first retaining element and a second retaining element of the same retaining mechanism, said first retaining element and said second retaining element being complementary and capable of cooperating with each other so that the retaining mechanism ensures locking of the male element in its locking position inside the at least one fastening orifice.

According to one embodiment of the disclosure, the first and second fastening elements may be hermaphroditic fastening elements, that is to say that the first and second fastening elements are both male and female.

According to one embodiment of the disclosure, the holding element is made at least in part of a ferromagnetic element, such as a magnet for example.

According to one embodiment of the disclosure, the formwork element is made at least in part of a magnetic material. Advantageously, the holding element is magnetically held in position on the internal side of the formwork element.

According to one embodiment of the disclosure, the fastening portion is positioned inside an internal space defined by the second portion.

According to one embodiment of the disclosure, the fastening portion is part of the same assembly as the internal part, thus forming a single-piece assembly.

According to one embodiment of the disclosure, the fastening portion is mounted inside the second portion so as to offer a possibility of displacement along at least one direction parallel to the orientation axis.

According to one embodiment of the disclosure, the fastening portion is mounted inside the second portion so as to offer a possibility of displacement in any direction on an axis parallel to the orientation axis.

According to one embodiment of the disclosure, the fastening portion is mounted inside the second portion so as to offer a possibility of displacement along at least one direction oriented transversely to the orientation axis.

According to one embodiment of the disclosure, the fastening device further includes a travel system interposed between the second portion and the fastening portion, the travel system being configured to exert a restoring force on the fastening portion towards a nominal position of the fastening portion, and to offer the possibility of displacement of the fastening portion with respect to the second portion.

According to one embodiment of the disclosure, the travel system comprises at least one elastically deformable fin.

According to one embodiment of the disclosure, the fastening portion further includes a conical portion, the conical portion including a vertex freely emerging inside the first securing element.

According to one embodiment of the disclosure, the fastening device further includes a corolla mechanically connecting the first portion and the second portion, said corolla being configured to deform elastically between a free position and a stressed position.

According to one embodiment of the disclosure, the elongation of the corolla can be preset according to at least two preset positions, said preset positions corresponding to different initial lengths of the fastening device when the latter occupies a free state.

Free state means a configuration in which the fastening device is not subject to any mechanical tensile or compressive stress.

According to one embodiment of the disclosure, the second portion externally defines an abutment surface, said abutment surface being configured to oppose the removal of the fastening device from the shuttered structure when a tensile force is exerted on the fastening portion.

According to one embodiment of the disclosure, the abutment surface is annular and/or frustoconical.

According to one embodiment of the disclosure, the fastening portion of the fastening device is configured to be visible from outside the shuttered structure when the at least one formwork element is removed after the shuttered structure has been poured and hardened. Thus, the location of the fastening portion can be easily identified with the naked eye, by photogrammetry or telemetry for example.

According to one embodiment of the disclosure, the pouring fluid may be concrete, resin, earth, plaster or expanded polystyrene for example.

According to one embodiment of the disclosure, the pouring fluid may be reinforced by a reinforcement element which is embedded in the pouring fluid.

According to one embodiment of the disclosure, the reinforcement element is configured to position one or several fastening devices vis-à-vis the at least one formwork element.

According to one embodiment of the disclosure, the fastening device includes a positioning element, such as a fastening clip for example, provided on the fastening portion of the internal part and configured to be secured to the reinforcement element. Such a configuration of the disclosure advantageously makes it possible to facilitate the installation of the fastening devices inside the formwork, on the one hand, and to increase the mechanical pull-out resistance of the internal part in the shuttered structure, on the other hand.

### BRIEF DESCRIPTION OF THE FIGURES

The present disclosure will be better understood with the aid of the following description with reference to the appended figures, in which identical reference signs correspond to structurally and/or functionally identical or similar elements.

FIG. 1 is a partial side view of a shuttered structure comprising an internal part of a fastening device according to one embodiment of the disclosure;

FIG. 2 is a side sectional view of the internal part according to the embodiment of FIG. 1;

FIG. 3 is a side sectional view of the internal part cooperating with an external part according to the embodiment of FIG. 1;

FIG. 4 is a top view of the internal part according to one variant of the embodiment of the disclosure;

FIG. 5 is a side sectional view of the internal part according to the variant of FIG. 3.

### DETAILED DESCRIPTION OF THE FIGURES

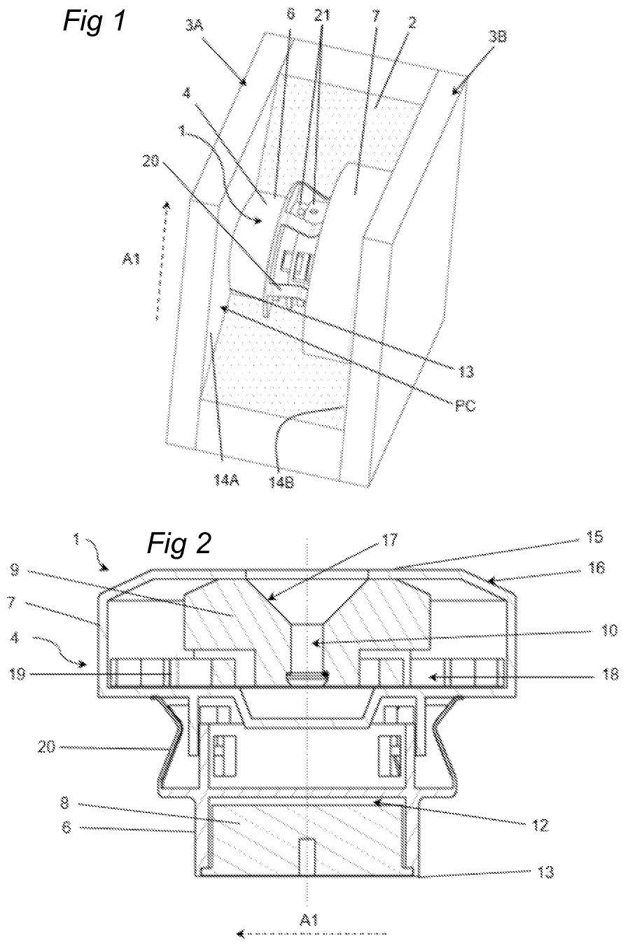

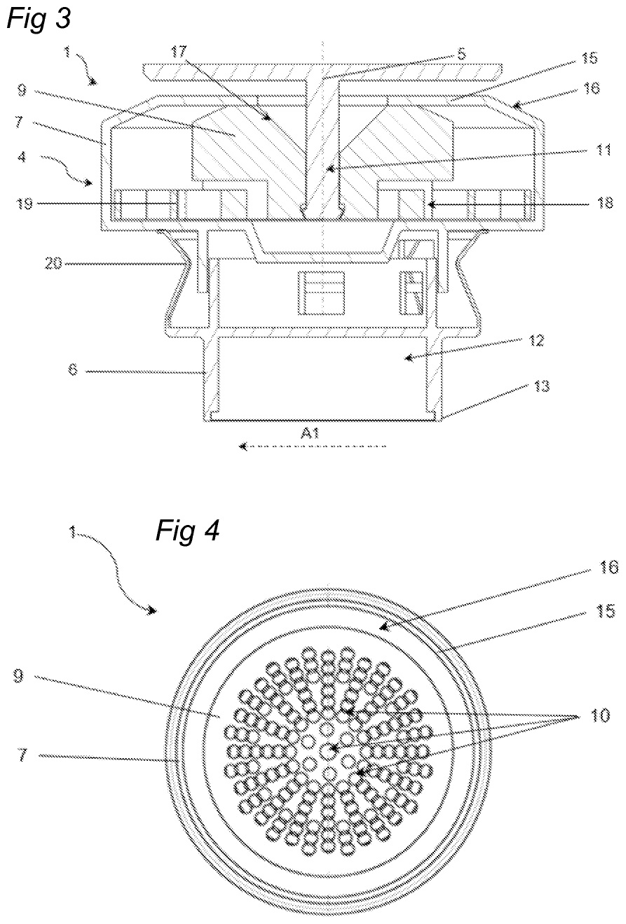

FIGS. 1 to 3 represent all or part of a fastening device 1 intended to ensure the fastening of an external functional element on a shuttered structure 2 such as a shuttered wall or a shuttered slab for example. The shuttered structure 2 extends substantially parallel to an orientation axis A1 and is obtained by pouring and hardening of a pouring fluid inside a formwork including at least one first formwork element 3A and one second formwork element 3B, such as a shuttering panel for example. By pouring fluid is meant any material compatible with being used in the field of construction such as concrete, resin, earth, plaster or expanded polystyrene for example. The pouring fluid can also be reinforced by a reinforcement element which is embedded in the pouring fluid.

By external functional element, is meant an element intended to totally or partially cover the shuttered structure 2, such as a facing element, a plasterboard, an acoustic and/or thermal insulation panel, a scaffolding element, a rod, a casing, a beam, a rail or a slab for example.

The fastening device 1 includes an internal part 4 intended to be embedded in the shuttered structure 2, as well as an external part 5 which makes it possible to ensure the holding of the external functional element vis-à-vis the internal part 4. Thus, the fastening device 1 allows the installation ant the holding in position of an external functional element on a shuttered structure 2 without having to resort to drilling or installing a fastening or bonding element after the hardening of the pouring fluid inside the formwork. Also, the internal part 4 is integrated into the shuttered structure 2 before carrying out the pouring of the pouring fluid inside the formwork, which makes it possible to obtain an optimal pull-out resistance of the internal part 4 inside the shuttered structure 2 once the construction material has fully solidified.

In one embodiment of the disclosure represented in FIGS. 1 to 3, the internal part 4 comprises a first portion 6, a second portion 7, a holding element 8 and a fastening portion 9 which defines a first securing element 10 configured to cooperate by shape complementarity with a second securing element 11 provided on the external part 5.

The first portion 6 internally defines a receiving area 12 which emerges outwards at a first peripheral edge 13. The first peripheral edge 13 is configured to extend opposite a first internal side 14A of the first formwork element 3A and substantially parallel to a contact plane PC.

In one embodiment of the disclosure, the holding element 8 is made at least in part of a ferromagnetic element, such as a magnet for example, while the first formwork element 3A is made at least in part of a magnetic material so that the holding element 8 is magnetically held in position on the first internal side 14A of the first formwork element 3A at the time of pouring. The holding element 8 is configured to alternately occupy an insertion position in which it is inserted inside the receiving area 12 so as to shut off the fluid communication between the receiving area 12 and the outside of the first portion 6, and a removal position in which the holding element 8 is configured to be able to be removed from the receiving area 12. Advantageously, the holding element 8 is removed after solidification of the pouring fluid in order to be reused during a subsequent implementation of the disclosure.

According to the embodiment of the disclosure as visible in the figures, the holding element 8 is flush with the first peripheral edge 13 at the contact plane PC and is in contact with the first internal side 14A of the first formwork element 3A. However, according to other embodiments of the disclosure not represented in the figures, it is conceivable that the holding element 8 protrudes with the first peripheral edge 13 when the holding element 8 occupies the insertion position, so that the holding element 8 is in contact against the first formwork element 3A; it is also conceivable that the peripheral edge protrudes with the holding element 8 when the holding element 8 occupies the insertion position, so that the first peripheral edge 13 is in contact against the first formwork element 3A.

The second portion 7 of the internal part 4 includes a second peripheral edge 15 configured to be in contact with a second internal side 14B of the second formwork element 3B. The second peripheral edge 15 is configured to provide a seal for said pouring fluid vis-à-vis the fastening portion 9. The second peripheral edge 15 is substantially contained in a plane intended to be parallel to the orientation axis A1 and to come against the second internal side 14B of the second formwork element 3B at the time of pouring. Furthermore, the second portion 7 externally defines an abutment surface 16. The abutment surface 16 is configured to oppose the removal of the fastening device 1 from the shuttered structure 2 when a tensile force is exerted on the fastening portion 9. The abutment surface 16 may be annular and/or frustoconical, or other, depending on the desired geometry of the fastening device 1.

The fastening portion 9 is provided inside an internal space defined by the second portion 7. The fastening portion 9 further includes a conical portion 17, the conical portion 17 having a vertex freely emerging inside the first securing element 10. In other words, the vertex of the conical portion 17 is the portion having the smallest section. Thus, the conical portion 17 converges in the direction of the first securing element 10 and opens in the direction of the second peripheral edge 15. The fastening portion 9 of the fastening device 1 is configured to be visible from the outside of the shuttered structure 2 when the formwork elements are removed after pouring and hardening of the shuttered structure 2. Thus, the location of the fastening portion 9 can be easily identified with the naked eye, by photogrammetry or telemetry for example.

According to the embodiment of the disclosure represented in FIGS. 1 to 3, the first securing element 10 is a fastening orifice, and the second securing element 11 is a male element capable of being inserted inside the fastening orifice following a movement oriented transversely to the contact plane PC to occupy a locking position. The fastening orifice and the male element respectively define a first retaining element and a second retaining element of the same retaining mechanism, the first retaining element and the second retaining element being complementary and capable of cooperating with each other so that the retaining mechanism ensures locking of the male element in its locking position inside the at least one fastening orifice. According to one embodiment of the disclosure not represented in the figures, the first securing element 10 and the second securing element 11 may also be hermaphroditic fastening elements, that is to say that they are both male and female.

The fastening device 1 further includes a travel system 18 which is interposed between the second portion 7 and the fastening portion 9 of the internal part 4. The travel system 18 is configured to exert a restoring force on the fastening portion 9 towards a nominal position of the fastening portion 9. The travel system 18 is configured to offer the possibility of displacement of the fastening portion 9 with respect to the second in any direction on a plane parallel to the contact plane PC. Furthermore, the travel system 18 can offer a possibility of displacement along a direction which is transverse to the contact plane PC. The travel system 18 is formed by means of a plurality of fins 19 which are each elastically deformable.

The internal part 4 further includes a corolla 20 which is configured to mechanically connect the first portion 6 and the second portion 7. The corolla 20 is configured to deform, elastically for example, between a free position and a stressed position. The elongation of the corolla 20 can be preset according to at least two preset positions 21. The preset positions 21 correspond to different initial lengths of the fastening device 1 when the latter occupies a free state. By free state is meant a configuration in which the fastening device 1 is not subjected to any mechanical tensile or compressive stress.

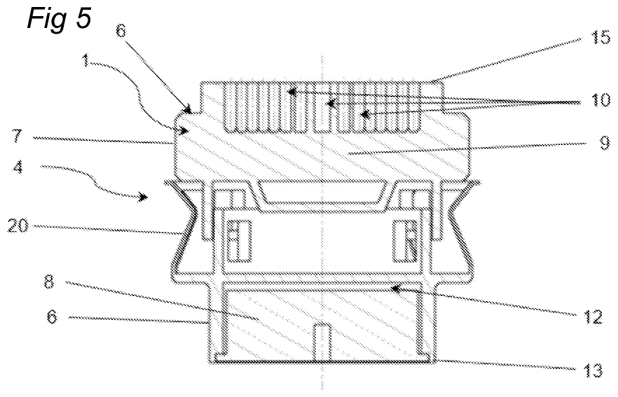

FIGS. 4 and 5 represent a variant of the embodiment of the disclosure. This variant differs in that the fastening portion 9 of the internal part 4 includes a plurality of first securing elements 10. It also differs in that the fastening portion 9 is part of the same assembly as the second portion 7, thus forming a single-piece assembly. Advantageously, this variant makes it possible to adapt to the position of the second securing element 11 without resorting to a mobile compensation system such as the travel system 18 represented in FIGS. 1 to 3.

According to one embodiment of the disclosure not represented in the figures, the fastening device 1 includes a positioning element, such as a fastening clip for example, provided on the fastening portion 9 of the internal part 4 and configured to be secured to a reinforcement element. The reinforcement element is then configured to position one or several fastening devices 1 vis-à-vis the first formwork element 3A and/or the second formwork element 3B.

Such a configuration of the disclosure advantageously makes it possible to facilitate the installation of the fastening devices 1 inside the formwork, on the one hand, and to increase the mechanical pull-out resistance of the internal part 4 in the shuttered structure 2 after hardening of the casting fluid, on the other hand.

Of course, the present disclosure is in no way limited to the embodiments described and illustrated, which have been given only as examples. Modifications remain possible, particularly from the point of view of the constitution of the various elements or by substitution of technical equivalents, without departing from the scope of protection of the disclosure.

1. A fastening device intended to ensure the fastening of an external functional element on a shuttered structure, such as a shuttered wall or a shuttered slab for example, the shuttered structure extending substantially parallel to an orientation axis and being obtained by pouring and hardening of a pouring fluid inside a formwork including at least one first formwork element and one second formwork element, such as a shuttering panel, the fastening device including:
an internal part intended to be at least partially embedded in the shuttered structure, and which comprises:
a) a first portion internally defining a receiving area emerging outwards at a first peripheral edge,
b) a holding element, configured to be in contact with a first internal side of the first formwork element at the time of said pouring, the holding element being capable of occupying an insertion position in which all or part of the holding element is inserted inside a portion of the receiving area, the holding element being configured to be able to be removed from the receiving area,
c) a second portion including a second peripheral edge configured to be in contact with a second internal side of the second formwork element and
d) a fastening portion configured to be accessible from the outside of the shuttered structure after hardening of the pouring fluid and removal of the formwork, the fastening portion defining at least one first securing element,
the fastening device further including an external part which comprises a second securing element configured to be secured to the fastening portion of the internal part the external part being intended to hold the external functional element in position relative to the internal part.

2. The fastening device according to claim 1, wherein the first peripheral edge is configured to provide a seal for said pouring fluid vis-à-vis the receiving area, the first peripheral edge being contained in a contact plane intended to be parallel to the orientation axis and to come against the first internal side of the first formwork element.

3. The fastening device according to claim 2, wherein the holding element is flush with the first peripheral edge along the contact plane when the holding element occupies the insertion position.

4. The fastening device according to claim 1, wherein the holding element protrudes relative to the first peripheral edge when the holding element occupies the insertion position, so that the holding element is in contact against the first formwork element without the peripheral edge being in contact against the first formwork element.

5. The fastening device according to claim 1, wherein the holding element is configured to provide a seal for the pouring fluid vis-à-vis the receiving area when the holding element occupies the insertion position.

6. The fastening device according to claim 1, wherein the second peripheral edge is configured to provide a seal for said pouring fluid vis-à-vis the fastening portion, the second peripheral edge being contained in a plane intended to be parallel to the orientation axis and to come against the second internal side of the second formwork element at the time of pouring.

7. The fastening device according to claim 1, wherein the at least one first securing element is a fastening orifice, and wherein the second securing element is a male element capable of being inserted inside said at least one fastening orifice following a movement oriented transversely to the orientation axis to occupy a locking position, the fastening orifice and the male element respectively defining a first retaining element and a second retaining element of the same retaining mechanism, said first retaining element and said second retaining element being complementary and capable of cooperating with each other so that the retaining mechanism ensures locking of the male element in its locking position inside the at least one fastening orifice.

8. The fastening device according to claim 1, wherein the holding element is made at least in part of a ferromagnetic element, such as a magnet for example.

9. The fastening device according to claim 1, wherein the fastening portion is positioned inside an internal space defined by the second portion.

10. The fastening device according to claim 1, wherein the fastening portion is mounted inside the second portion so as to offer a possibility of displacement along at least one direction parallel to the orientation axis.

11. The fastening device according to claim 10, wherein the fastening portion is mounted inside the second portion so as to offer a possibility of displacement in any direction on an axis parallel to the orientation axis.

12. The fastening device according to claim 1, wherein the fastening portion is mounted inside the second portion so as to offer a possibility of displacement along at least one direction oriented transversely to the orientation axis.

13. The fastening device according to claim 10, which further includes a travel system interposed between the second portion and the fastening portion, the travel system being configured to exert a restoring force on the fastening portion towards a nominal position of the fastening portion, and to offer the possibility of displacement of the fastening portion with respect to the second portion.

14. The fastening device according to claim 13, wherein the travel system comprises at least one elastically deformable fin.

15. The fastening device according to claim 1, wherein the fastening portion further includes a conical portion, the conical portion including a vertex emerging freely inside the first securing element.

16. The fastening device according to claim 1, which further includes a corolla mechanically connecting the first portion and the second portion, said corolla being configured to deform elastically between a free position and a stressed position.

17. The fastening device according to claim 16, wherein the elongation of the corolla may be preset according to at least two preset positions, said preset positions corresponding to different initial lengths of the fastening device when the latter occupies a free state.

18. The fastening device according to claim 1, wherein the second portion externally defines an abutment surface, said abutment surface being configured to oppose the removal of the fastening device from the shuttered structure when a tensile force is exerted on the fastening portion.
